(19) United States
(12) Patent Application Publication
(10) Pub. No.: US 2025/0183588 A1
(43) Pub. Date: Jun. 5, 2025

(54) CONNECTOR

(71) Applicant: SUMITOMO WIRING SYSTEMS, LTD., Mie (JP)

(72) Inventors: Daisuke KATAOKA, Mie (JP); Junya MATSUURA, Mie (JP)

(21) Appl. No.: 18/843,708

(22) PCT Filed: Feb. 16, 2023
(86) PCT No.: PCT/JP2023/005367

§ 371 Date: Sep. 4, 2024

(30) Foreign Application Priority Data
Mar. 8, 2022 (JP) 2022-035249

(51) Int. Cl. H01R 13/631; H01R 13/502; H01R 13/52; H01R 13/629

(52) U.S. Cl. CPC H01R 13/631; H01R 13/502; H01R 13/5205; H01R 13/62938

(57) ABSTRACT

A housing (11) includes a first member (16) for supporting a slider (14) serving as a lever member and a second member (17) for accommodating a sealing member (15) in an accommodation space (25) formed between the first member (16) and the second member (17) to sandwich the sealing member (15) in a front-rear direction. The second member (17) includes a pressed portion (29). The lever member includes a pressing portion (65) for pressing the second member (17) in a direction to reduce a dimension in the front-rear direction of the accommodation space (25) by contacting the pressed portion (29). The pressed portion (29) is arranged in a non-engaged state with the lever member until contacting the pressing portion (65) in a displacement process.

### TECHNICAL FIELD

The present disclosure relates to a connector.

### BACKGROUND

A connector of Patent Document 1 is provided with a housing connectable to a mating connector, a rear holder to be mounted on a rear part of the housing and a slide lever movably supported in the housing. The slide lever connects the housing and the mating connector by moving with respect to the housing. The rear holder includes a rear holder cam pin. The slide lever includes a rear holder cam groove engageable with the rear holder cam pin.

Patent Document 2 discloses a technique for connecting a housing and a mating connector by a rotary lever member. A rear holder of Patent Document 2 includes a clamping projection. The lever member includes a cam projection engageable with the clamping projection.

In the case of Patent Document 1 and 2, a sealing member is held in a compressed state between the rear holder and the housing when the housing and the mating connector are in a connected state. During the compression of the sealing member, a sealing hole (part called a rubber plug side insertion hole in Patent Document 1 and called a through hole in Patent Document 2) is reduced in diameter and the sealing member can be held in close contact with the outer peripheral surface of a wire in a liquid-tight manner. When the sealing member is in a natural state, an inner diameter of the sealing hole can be larger than that during diameter reduction, wherefore the rigidity of a mold pin for forming the sealing hole can be ensured even if the sealing member is small in size.

### PRIOR ART DOCUMENT

### Patent Document

Patent Document 1: JP 2011-175840 A
Patent Document 2: JP 2004-288500 A

### SUMMARY OF THE INVENTION

### Problems to be Solved

In the case of Patent Document 2, the clamping projection is engaged with the cam projection over an entire rotation stroke of the lever member. Also in the case of Patent Document 1, the rear holder cam pin of the rear holder is engageable with the groove surface of the rear holder cam groove of the slide lever. Then, during the operation of the lever member (including the slide lever), engagement resistance of the lever member and the rear holder is added in addition to normal connection resistance, which may pose an obstacle in further improving operability.

Accordingly, the present disclosure aims to provide a connector capable of improving operability in connecting a housing and a mating connector.

### Means to Solve the Problem

The present disclosure is directed to a connector with a housing connectable to a mating connector, a sealing member arranged in the housing, the sealing member sealing an outer peripheral surface of a wire, and a lever member arranged displaceably with respect to the housing, the lever member connecting the housing and the mating connector, the housing including a first member for supporting the lever member and a second member for accommodating the sealing member in an accommodation space formed between the first member and the second member to sandwich the sealing member in a connection direction of the housing to the mating connector, the second member including a pressed portion, the lever member including a pressing portion for pressing the second member in a direction to reduce a dimension in the connection direction of the accommodation space by contacting the pressed portion, and the pressed portion being arranged in a non-engaged state with the lever member until contacting the pressing portion in a displacement process of the lever member.

### Effect of the Invention

According to the present disclosure, it is possible to provide a connector capable of improving operability in connecting a housing and a mating connector.

### BRIEF DESCRIPTION OF THE DRAWINGS

FIG. 1 is an exploded perspective view of a connector according to one embodiment.

FIG. 2 is a section showing a state where a housing and a mating connector are properly connected.

FIG. 3 is a front view of the mating connector.

FIG. 4 is a perspective view of a second member when viewed obliquely from an upper rear side.

FIG. 5 is a front view of the second member.

FIG. 6 is a perspective view of a first member when viewed obliquely from a lower front side.

FIG. 7 is a back view of the first member.

FIG. 8 is a side view of the first member.

FIG. 9 is a front view of an operating member.

FIG. 10 is a plan view of a slider.

FIG. 11 is a bottom view of the slider.

FIG. 12 is a front view of a sealing member.

FIG. 13 is a plan view showing a state where the slider is arranged at a movement start position and the housing and the mating connector are lightly connected.

FIG. 14 is a section showing a positional relationship of pressed portions and pressing portions in a latter period of a moving process of the slider.

FIG. 15 is a section showing a positional relationship of the respective pressed portions and the respective pressing portions with the slider located at a movement completion position.

FIG. 16 is a partial enlarged section showing a state where the pressed portion is on a top surface of the pressing portion and a contact surface of the pressed portion and the top surface of the pressing portion are in contact in a state of FIG. 15.

FIG. 17 is a partial enlarged section showing a state where a first lock portion and a second lock portion are arranged to be lockable to each other when the slider is at the movement start position.

FIG. 18 is a partial enlarged section showing a state where a lock projection of the second lock portion is arranged away from a first lock edge of the first lock portion when the slider is at the movement completion position.

FIG. 19 is a partial enlarged perspective view showing the state of FIG. 18 when viewed laterally.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing connectable to a mating connector, a sealing member arranged in the housing, the sealing member sealing an outer peripheral surface of a wire, and a lever member arranged displaceably with respect to the housing, the lever member connecting the housing and the mating connector, the housing including a first member for supporting the lever member and a second member for accommodating the sealing member in an accommodation space formed between the first member and the second member to sandwich the sealing member in a connection direction of the housing to the mating connector, the second member including a pressed portion, the lever member including a pressing portion for pressing the second member in a direction to reduce a dimension in the connection direction of the accommodation space by contacting the pressed portion, and the pressed portion being arranged in a non-engaged state with the lever member until contacting the pressing portion in a displacement process of the lever member.

When the housing and the mating connector are in the connected state, the pressing portion contacts the pressed portion to press the second member and reduce the dimension in the connection direction of the accommodation space. Thus, the sealing member can be compressed and held in close contact with the outer peripheral surface of a wire in a liquid-tight manner. As a result, the sealability of the sealing member can be ensured.

Since the pressed portion and the lever member are arranged in the non-engaged state until the pressed portion contacts the pressing portion in the displacement process of the lever member, it can be avoided that engagement resistance is generated between the pressed portion and the lever member, and operability in connecting the housing and the mating connector can be improved.

(2) Preferably, the pressing portion presses the second member rearward in the connection direction, the first member is configured as a box-shaped frame open forward in the connection direction, and the second member is accommodated into the first member to form the accommodation space between a rear wall portion of the first member and the second member.

The first member can have a function of a rear holder for restricting the sealing member from coming out rearward in addition to a function of supporting a slider. Thus, the connector needs not be provided with the rear holder serving as a dedicated member and the number of components can be reduced.

(3) The first member may include a recess extending in the connection direction, and the pressed portion is configured as a guide arranged displaceably in the recess. The pressed portion can have a function as a movement guide of the second member with respect to the first member in addition to a function of being pressed by the pressed portion in the second member.

(4) The lever member may include a cam groove, the cam groove may include a cam engaging portion to be engaged with a cam pin of the mating connector and a play portion continuous with the cam engaging portion in a back end part of the cam groove and not engaged with the cam pin, and the pressing portion and the pressed portion may be set to contact when the cam pin is located in the play portion.

A state where engagement resistance between the pressing portion and the pressed portion is not generated can be set while the cam pin is engaged with the cam engaging portion and connection resistance between the housing and the mating connector is generated. On the other hand, a state where connection resistance between the housing and the mating connector is not generated can be set while engagement resistance between the pressing portion and the pressed portion is generated. Thus, it can be prevented that the connection resistance and the engagement resistance are simultaneously generated, and operability can be further improved.

(5) The lever member may be a slider configured to reach a movement completion position by moving in a direction intersecting the connection direction with respect to the first member, a plurality of the pressing portions may be arranged side by side in a moving direction of the slider in the slider, each of the plurality of pressing portions may have a top surface to be held in contact with a contact surface of the pressed portion in a connected state of the housing and the mating connector, the top surface of the pressing portion located more on a front side in the moving direction of the slider to the movement completion position, out of the plurality of pressing portions, may be arranged more forward in the connection direction, a plurality of the pressed portions may be arranged side by side to correspond to the plurality of pressing portions in the second member, and the contact surface of the pressed portion located more on the front side in the moving direction of the slider to the movement completion position, out of the plurality of pressed portions, may be arranged more forward in the connection direction.

If the pressing portion and the pressed portion are configured to contact only at one position in the moving direction of the slider when the second member is shaped to be long in the moving direction of the slider, a force may be applied in a tilting direction (direction to tilt with respect to a front-rear direction) to the second member and the second member may not be able to smoothly move by being pressed by the pressing portion.

In contrast, since the plurality of pressing portions and the plurality of pressed portions are provided and contact at a plurality of positions in the moving direction of the slider according to the above configuration, a force is less likely to be applied in the tilting direction to the second member and the second member can smoothly move. Particularly, since the top surface of the pressing portion and the contact surface of the pressed portion located more on the front side in the moving direction of the slider to the movement completion position are both arranged more forward, the respective pressing portions and the respective pressed portions can be collectively brought into contact at the same timing in a latter period of a moving process of the slider.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

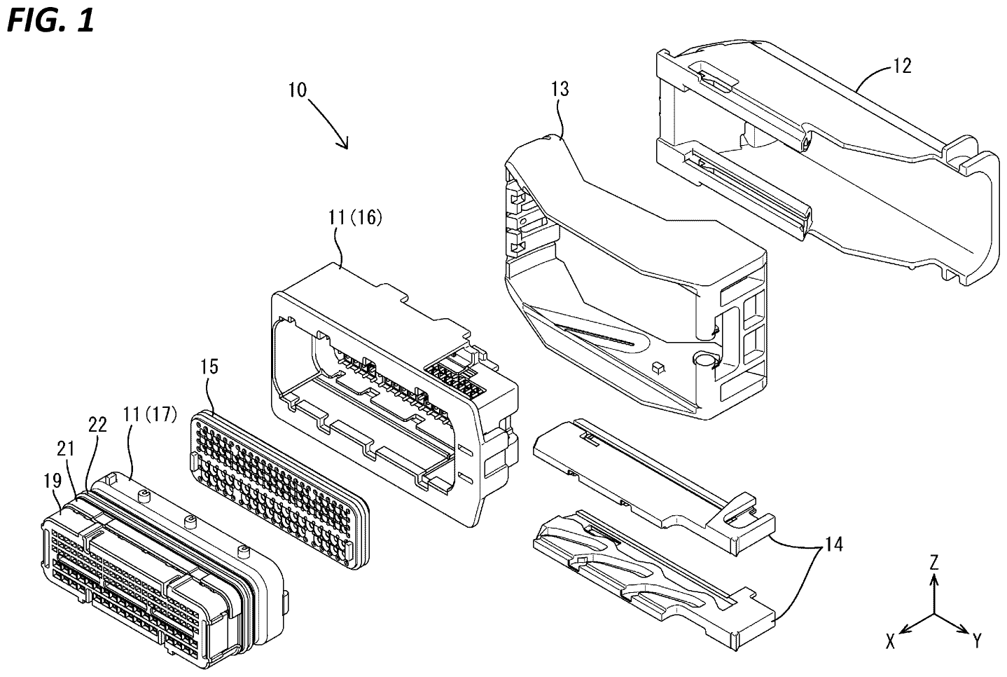

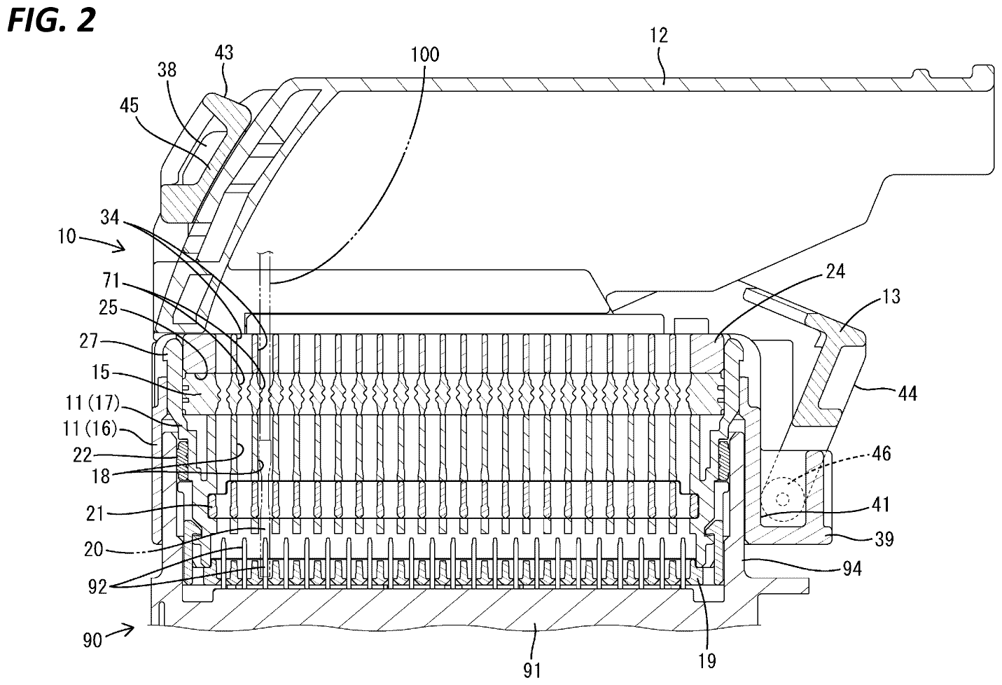

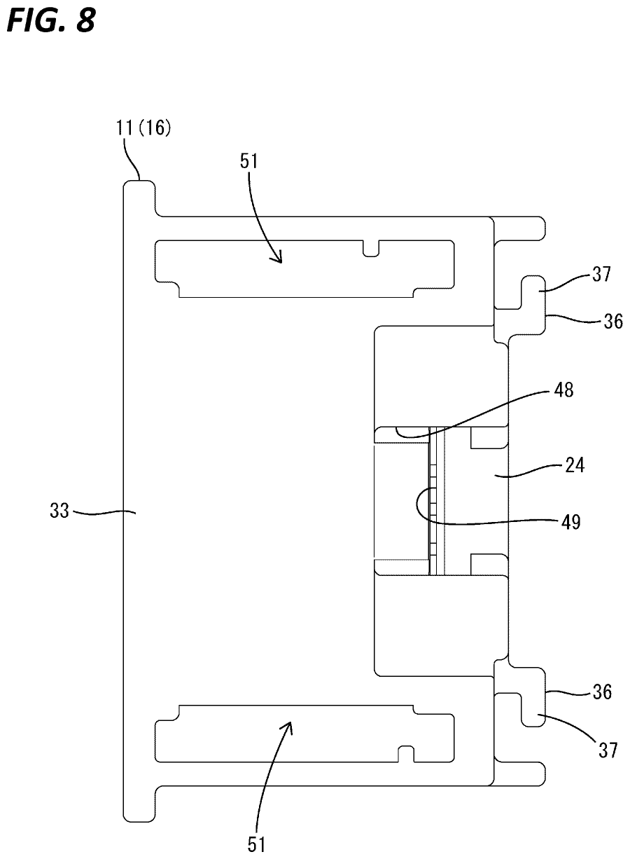

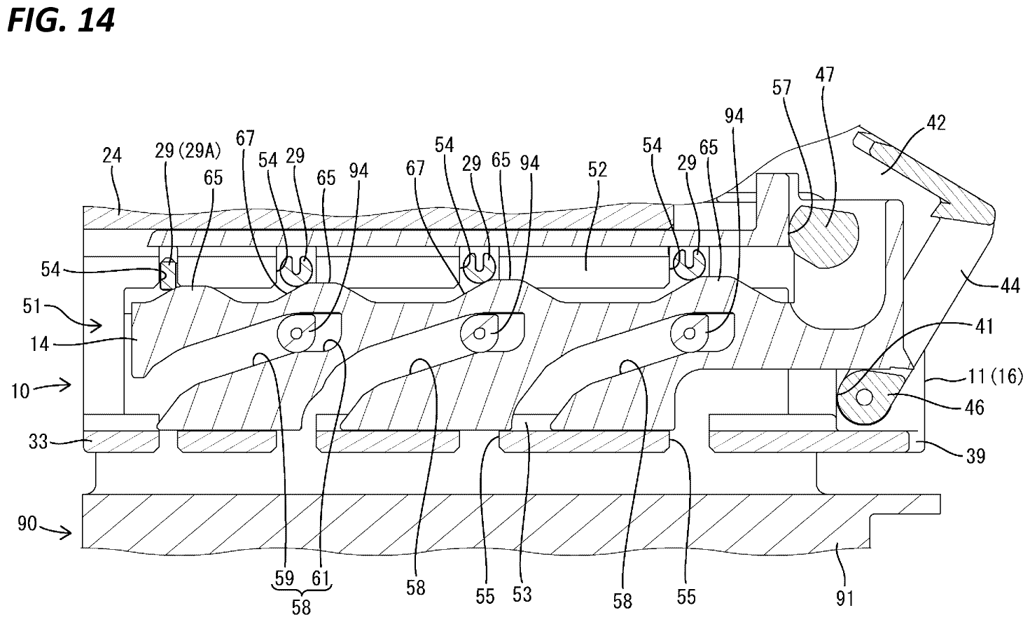

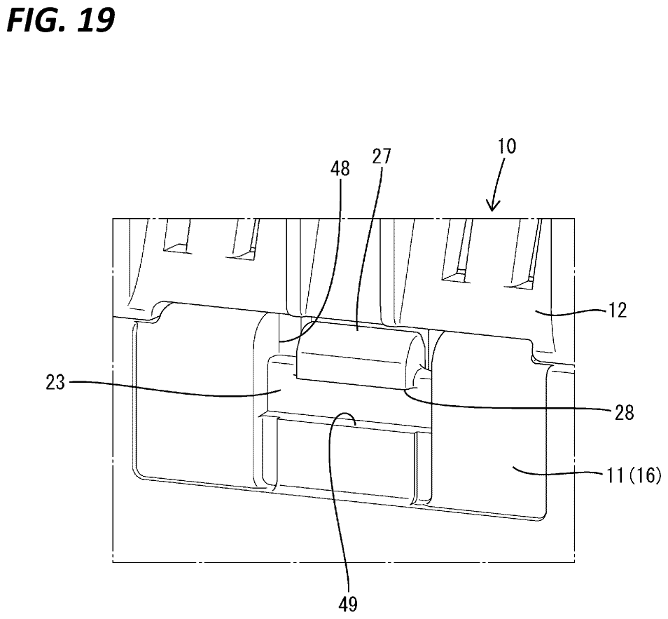

A connector 10 according to one embodiment of the present disclosure is, as shown in FIG. 1, provided with a housing 11, a wire cover 12, an operating member 13, a pair of sliders 14 and a sealing member 15. As shown in FIG. 2, the housing 11 is connectable to a mating connector 90. Note that, in the following description, surface sides facing each other when the connection of the housing 11 and the mating connector 90 is started are referred to as front sides concerning a front-rear direction. A vertical direction is based on a vertical direction of each of FIGS. 1, 3 to 9 and 12. A lateral direction is based on a lateral direction of each figure except FIGS. 8 and 19. As described later, a left side of FIG. 14 is a front side in a moving direction of the slider 14. These directions do not necessarily coincide with directions in a state where the connector 10 is installed in a vehicle or the like. In FIG. 1, the front side is indicated by an arrow X, a right side is indicated by an arrow Y and an upper side is indicated by an arrow Z.

### <Mating Connector>

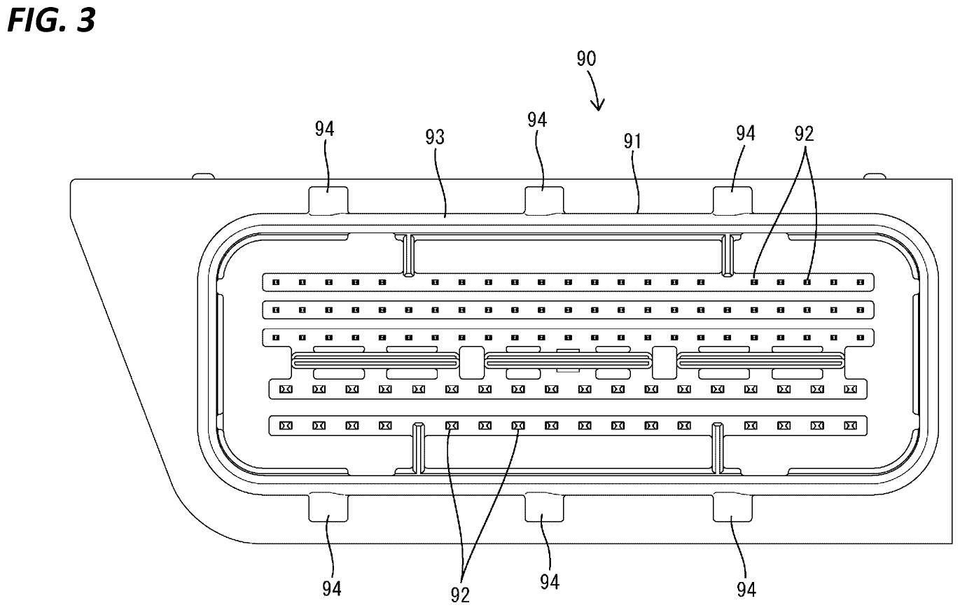

As shown in FIG. 3, the mating connector 90 is provided with a mating housing 91 and mating terminal fittings 92.

The mating housing 91 is made of synthetic resin and includes a tubular receptacle 93 long in the lateral direction. The receptacle 93 is open forward. The mating terminal fitting 92 is made of electrically conductive metal and, as shown in FIG. 2, in the form of a tab, and a plurality of the mating terminal fittings 92 are arranged to project into the receptacle 93. The rear end of the mating terminal fitting 92 is electrically connected to an unillustrated circuit board.

As shown in FIG. 3, a plurality of, three in this embodiment, cam pins 94 projecting upward are formed on the upper wall of the receptacle 93. A plurality of, three in this embodiment, cam pins 94 projecting downward are also formed on the lower wall of the receptacle 93. The respective cam pins 94 are arranged side by side at intervals in the lateral direction on each of the upper and lower walls of the receptacle 93.

### <Housing, Wire Cover, Operating Member>

The housing 11 is made of synthetic resin and includes, as shown in FIG. 2, a first member 16 and a second member 17 to be assembled with each other.

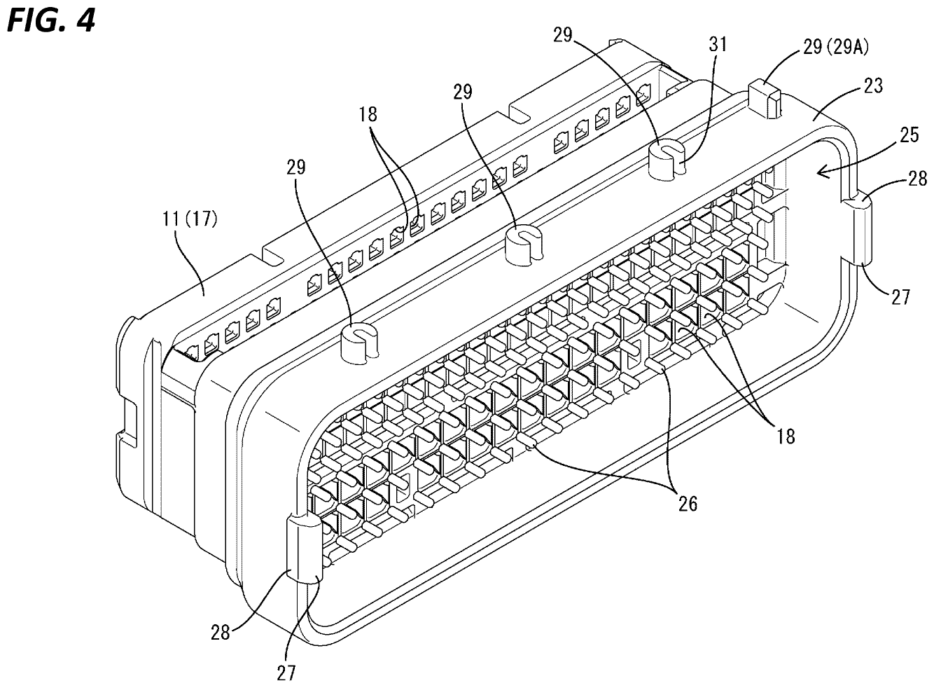

As shown in FIGS. 1 and 4, the second member 17 is shaped to be long in the lateral direction. As shown in FIG. 2, the second member 17 is formed with a plurality of cavities 18 penetrating in the front-rear direction. A terminal fitting 20 (only one is shown in FIG. 2) is inserted and accommodated into each cavity 18 from behind. The terminal fitting 20 is a female terminal made of electrically conductive metal and crimped to an end part of a wire 100. When the housing 11 and the mating connector 90 are in a connected state, the mating terminal fittings 92 are inserted and electrically connected to the terminal fittings 20.

As shown in FIGS. 1 and 2, a front holder 19 is mounted on a front end part of the second member 17. A retainer 21 is mounted in an intermediate part in the front-rear direction of the second member 17. The retainer 21 secondarily locks the terminal fittings 20 inserted into the cavities 18. A sealing ring 22 is fit on the outer peripheral surface of the second member 17. The sealing ring 22 is compressed between the housing 11 and the receptacle 93, whereby the housing 11 and the mating connector 90 are connected in a liquid-tight manner.

As shown in FIG. 4, a tubular portion 23 is formed in a rear end of the second member 17. The inside of the tubular portion 23 is open rearward and an accommodation space 25 for accommodating the sealing member 15 is formed between the tubular portion 23 and a rear wall portion 24 of the first member 16 to be described later. The rear surface (surface facing the accommodation space 25) of the second member 17 is formed with a plurality of second positioning pins 26 projecting rearward (toward the accommodation space 25) from four corner parts of each cavity 18.

A pair of second lock portions 27 projecting rearward are formed in vertically intermediate parts of left and right side walls of the tubular portion 23. Each second lock portion 27 is in the form of a plate long in the vertical direction. A second lock projection 28 projecting outward (toward a side opposite to a side facing the mating second lock portion 27) is formed in a rear end part of each second lock portion 27.

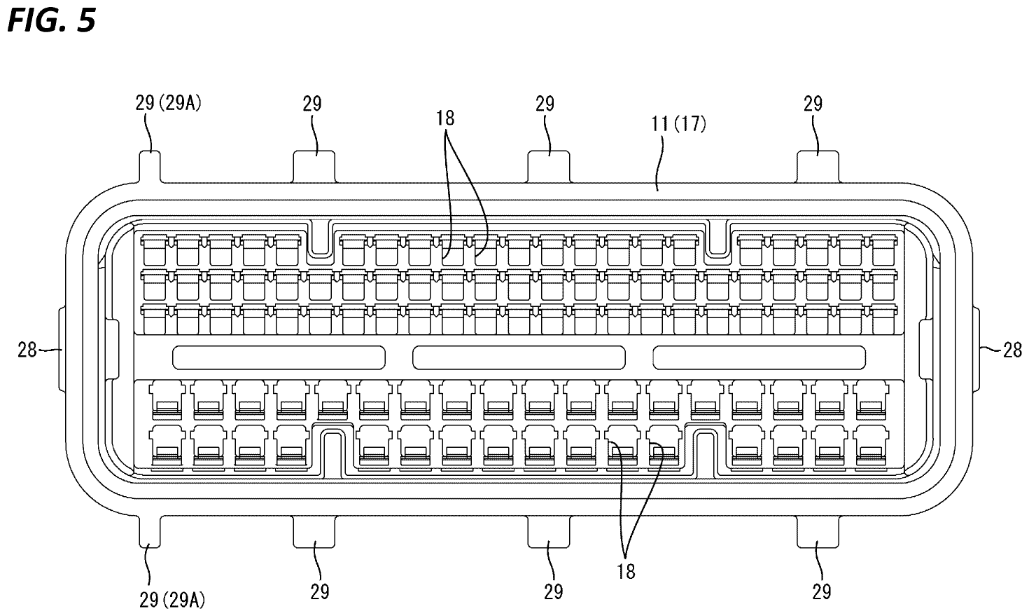

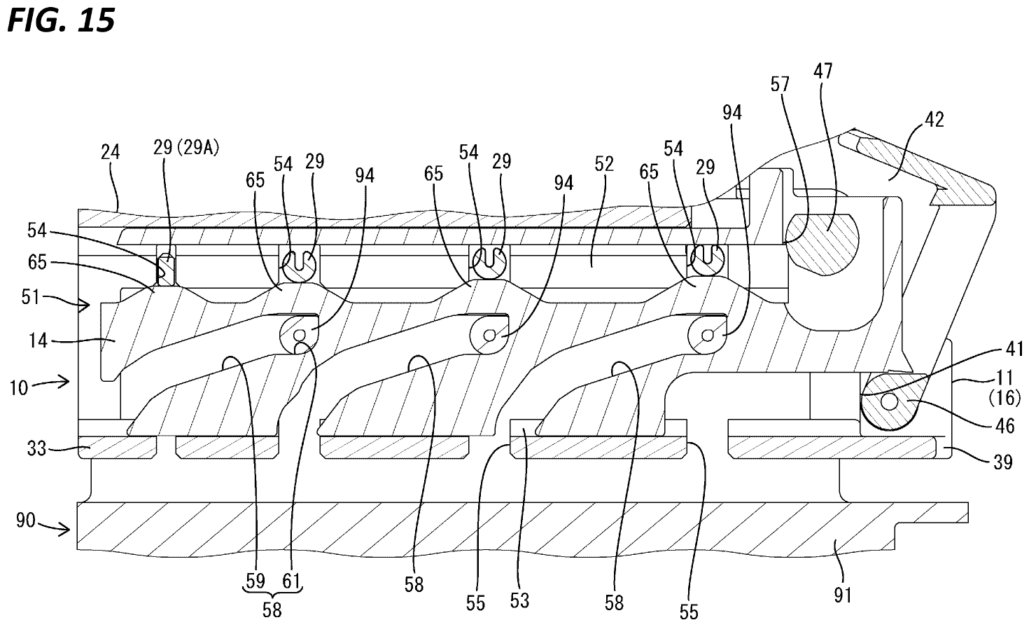

A plurality of, four in the case of this embodiment, pressed portions 29 projecting upward are formed on the upper wall of the tubular portion 23. As shown in FIG. 5, a plurality of, four in the case of this embodiment, pressed portions 29 projecting downward are also formed on the lower wall of the tubular portion 23. The respective pressed portions 29 have a cylindrical shape except the pressed portions 29A on a right end part of FIG. 4 (left end part in the case of FIG. 5) and include a lightening slit 31 extending forward from a rear end. When the housing 11 and the mating connector 90 are in the connected state, the respective pressed portions 29 (except the pressed portions 29A) are coaxially arranged in front of the respective cam pins 94 as shown in FIG. 15. Note that the pressed portion 29A is in the form of a rib extending in the front-rear direction and formed to have a smaller lateral dimension than the other pressed portions 29.

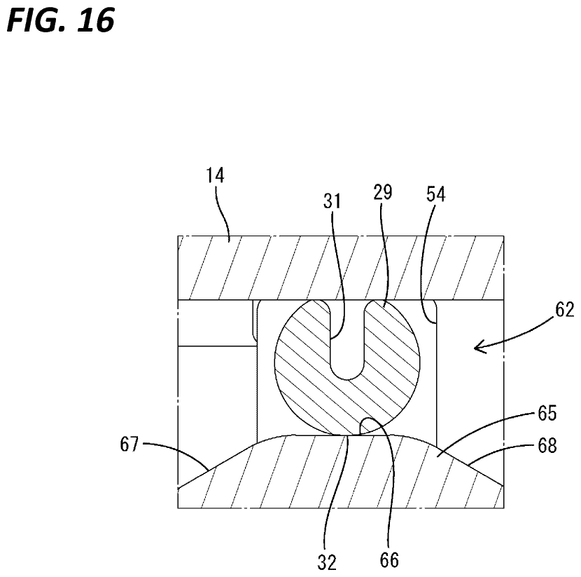

The front end of each pressed portion 29 is formed into a convex curved surface and configured as a contact surface 32 to be held in contact with a top surface 66 of a pressing portion 65 to be described later as shown in FIG. 16.

The respective pressed portions 29 are arranged side by side at intervals in the lateral direction on each of the upper and lower walls of the tubular portion 23. The positions in the front-rear direction of the respective pressed portions 29 are changed in a stepwise manner as shown in FIGS. 14 and 15 on each of the upper and lower walls of the tubular portion 23. Specifically, the pressed portion 29 located more on the left side (front side in a moving direction when the slider 14 moves from a movement start position to a movement completion position) of FIGS. 14 and 15 is arranged more forward. Thus, the contact surface 32 of the pressed portion 29 located more on the front side in the moving direction of the slider 14 is arranged more forward.

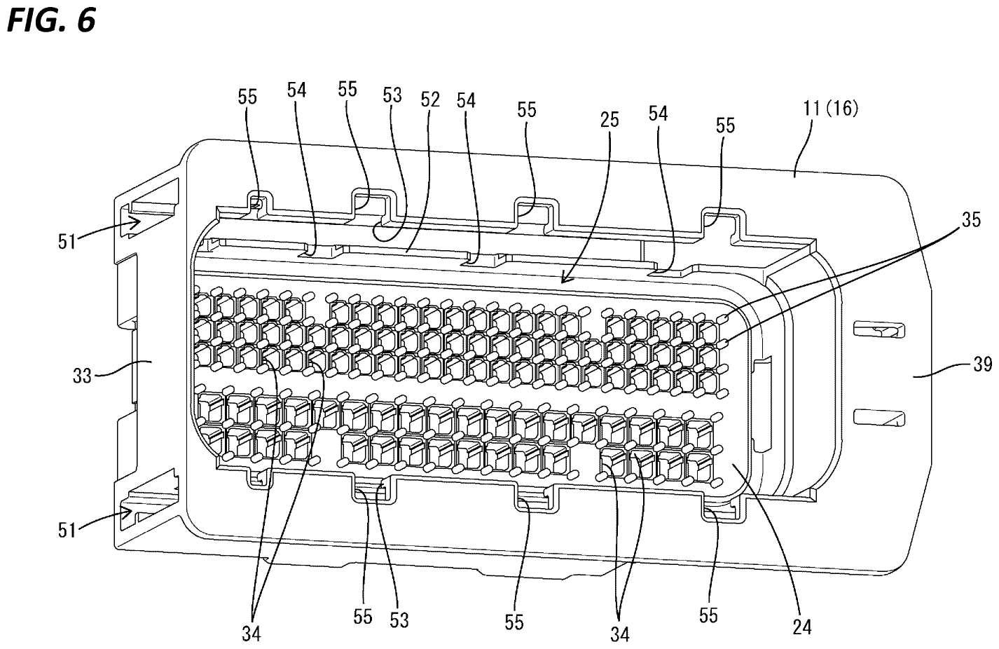

As shown in FIGS. 1 and 6, the first member 16 is configured as a rectangular tubular frame. As shown in FIG. 6, the first member 16 includes a fitting tube portion 33 and the rear wall portion 24 closing a rear end part of the fitting tube portion 33. The fitting tube portion 33 is in the form of a rectangular tube long in the lateral direction and open forward. The rear wall portion 24 is arranged with wall surfaces facing in the front-rear direction in a rear end part of the fitting tube portion 33.

As shown in FIG. 2, the second member 17 is inserted and accommodated into the fitting tube portion 33 from front. The rear wall portion 24 is formed with a plurality of through holes 34 penetrating in the front-rear direction at positions corresponding to the respective cavities 18. As shown in FIG. 6, the front surface (surface facing the accommodation space 25) of the rear wall portion 24 is formed with a plurality of first positioning pins 35 projecting forward (toward the accommodation space 25) from four corner parts of each through hole 34.

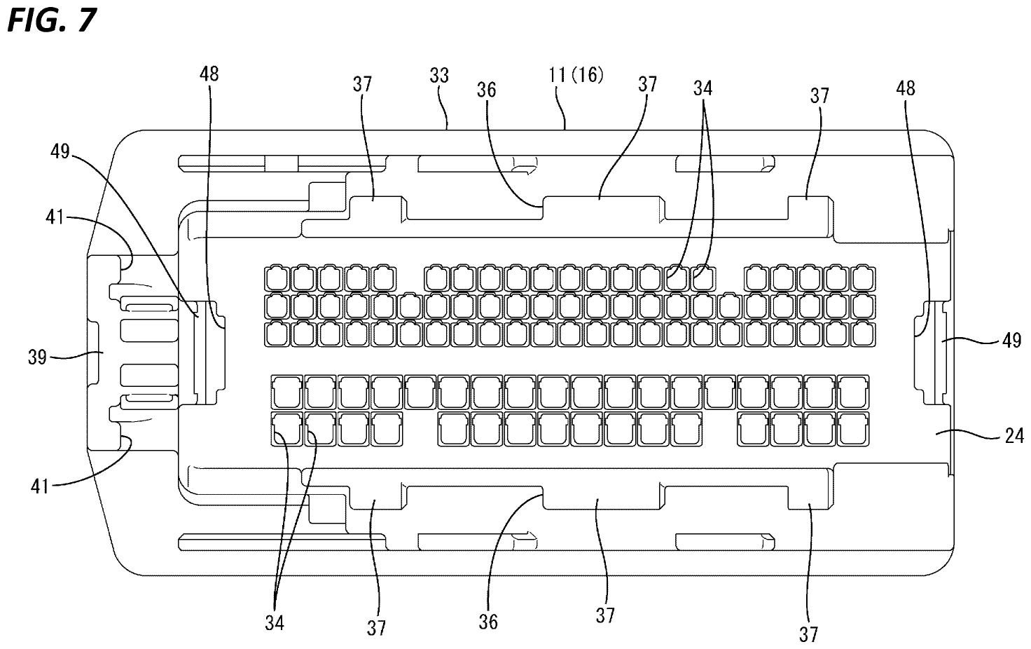

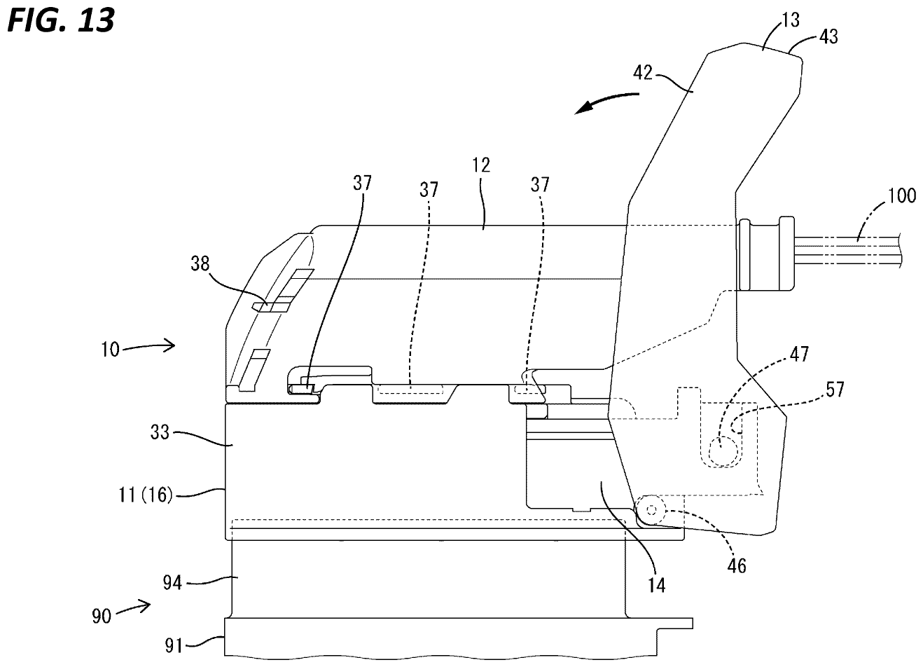

As shown in FIG. 7, the rear surface of the rear wall portion 24 is formed with a cover mounting portion 36. The cover mounting portion 36 includes a plurality of projecting pieces 37 on each of an upper side and a lower side across the respective through holes 34 in the rear surface of the rear wall portion 24. As shown in FIG. 13, the wire cover 12 is engaged with the respective projecting pieces 37 of the cover mounting portion 36 and mounted while being restricted from coming out rearward from the first member 16.

The wire cover 12 is made of synthetic resin, cap-shaped and mounted on the first member 16 to cover the rear surface of the rear wall portion 24. The wires 100 connected to the respective terminal fittings 20 are pulled out sideways, rightward of FIG. 13 in the case of this embodiment, through the inside of the wire cover 12 from the rear surface of the rear wall portion 24. A cover-side lock portion 38 is formed on the left end surface of the wire cover 12 in FIG. 13.

The fitting tube portion 33 is formed with a projecting portion 39 projecting leftward in FIG. 7. The projecting portion 39 is formed with a pair of upper and lower bearing portions 41 open rearward. As shown in FIG. 2, the operating member 13 is supported rotatably in the bearing portions 41 of the first member 16 and the rotation thereof is restricted by being locked by the cover-side lock portion 38.

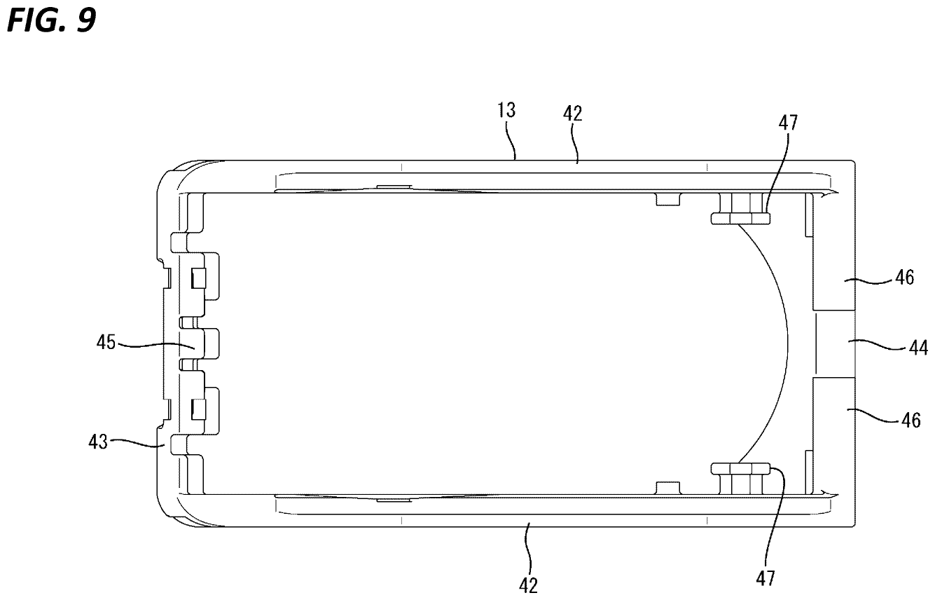

The operating member 13 is made of synthetic resin and, as shown in FIG. 9, in the form of a rectangular frame as a whole. The operating member 13 includes a pair of operation arms 42 facing each other in the vertical direction and a pair of coupling portions 43, 44 coupling end parts in the lateral direction of the respective operation arms 42. A worker can rotate the operating member 13 while pinching the coupling portion 43 on a left side of FIG. 9, out of the respective coupling portions 43, 44. The coupling portion 43 on the left side of FIG. 9 is formed with an operation lock portion 45.

A pair of rotary shafts 46 projecting inward to face each other are formed on end parts of the respective operation arms 42 near the coupling portion 44 on a right side of FIG. 9. Each rotary shaft 46 has a cylindrical shape. As shown in FIGS. 14 and 15, the operating member 13 is rotatable about the respective rotary shafts 46 fit in the bearing portions 41 of the first member 16. As shown in FIG. 9, a pair of slide cam portions 47 projecting inward are formed on parts of the respective operation arms 42 near the rotary shafts 46. Each slide cam portion 47 is formed to have a smaller projecting dimension than each rotary shaft 46. A tip part in a projecting direction of the slide cam portion 47 is formed into a cam shape engageable with a slide cam receiving portion 57 to be described later as shown in FIGS. 14 and 15.

As shown in FIG. 7, the first member 16 is formed with a pair of first lock portions 48 penetrating through rear end parts of left and right side walls of the fitting tube portion 33. As shown in FIG. 8, the first lock portion 48 has a rectangular opening shape in a side view. A vertically intermediate part of the rear wall portion 24 can be visually confirmed through the first lock portion 48 from a lateral side. The first lock portion 48 includes a first lock edge 49 along the vertical direction as a front opening edge.

As shown in FIGS. 6 and 8, a supporting hole 51 extending in the lateral direction is formed in each of an upper end and a lower end part inside the fitting tube portion 33. As shown in FIGS. 14 and 15, the slider 14 is inserted into the supporting hole 51 and movable in the lateral direction. One end part of each supporting hole 51 penetrates through one side wall of the fitting tube portion 33 and has a rectangular opening shape long in the front-rear direction in a side view as shown in FIG. 8.

Slide rail portions 52, 53 extending in the lateral direction while facing each in the front-rear direction are provided on an inner side of each supporting hole 51 inside the fitting tube portion 33 as shown in FIGS. 6, 14 and 15. Out of the respective slide rail portions 52, 53, the rear slide rail portions 52 located on a rear side define an upper side (see FIG. 6) and a lower side of the accommodation space 25.

The rear slide rail portion 52 is formed with a plurality of recesses 54 extending short in the front-rear direction. Each recess 54 is cut into a rectangular shape and open in the front end of the rear slide rail portion 52. As shown in FIGS. 14 and 15, the respective recesses 54 are arranged side by side at intervals in the lateral direction at positions corresponding to the respective pressed portions 29 in the rear slide rail portion 52.

Out of the respective slide rail portions 52, 53, the front slide rail portions 53 arranged on a front side are formed with through holes 55 extending in the front-rear direction and penetrating through a front wall part of the fitting tube portion 33 (front surface parts of the upper and lower walls of the fitting tube portion 33) as shown in FIG. 15. The respective through holes 55 are arranged side by side at intervals in the lateral direction at positions facing the respective recesses 54 in the front wall part of the fitting tube portion 33 and the front slide rail portions 53. Each cam pin 94 is inserted into each through hole 55 from front when the connection of the housing 11 and the mating connector 90 is started.

### <Sliders>

The sliders 14 are configured as a lever member. As shown in FIG. 1, the pair of sliders 14 are formed in the vertical direction to correspond to the respective supporting holes 51. Each slider 14 is in the form of a plate long in the lateral direction.

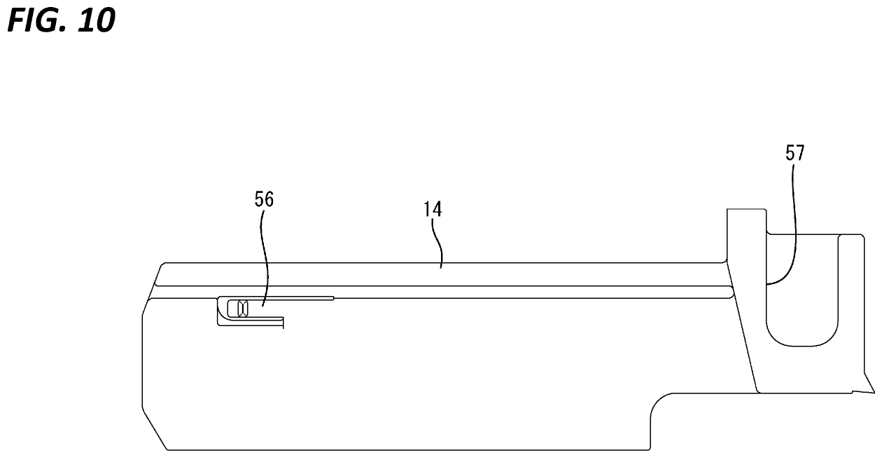

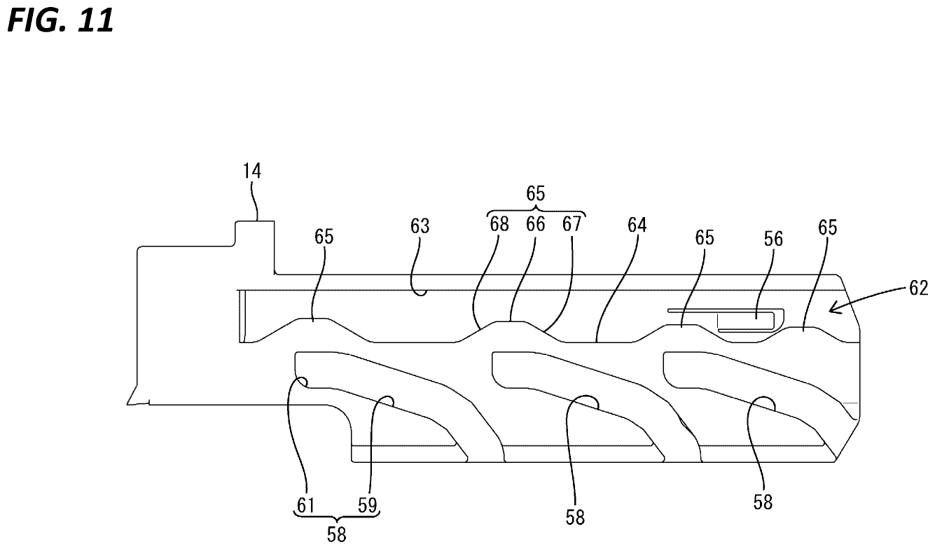

As shown in FIGS. 10 and 11, the slider 14 is formed with a resilient lock portion 56 extending in the lateral direction. The resilient lock portion 56 is lockable to the fitting tube portion 33 when a movement of the slider 14 is stopped.

As shown in FIG. 10, the slide cam receiving portion 57 is provided by recessing the outer surface of the slider 14 near a right end part of FIG. 10. The slide cam receiving portion 57 is open into a U shape in the rear end of the slider 14. By rotting the operating member 13 and sliding the slide cam portion 47 on an edge part of the slide cam receiving portion 57, the slider 14 can move with respect to the housing 11 as shown in FIGS. 14 and 15.

As shown in FIG. 11, a plurality of, three in the case of this embodiment, cam grooves 58 are provided by recessing the inner surface (surface facing the mating slider 14) of each slider 14. The respective cam grooves 58 are respectively arranged side by side at intervals in the lateral direction in the inner surface of the slider 14.

Each cam groove 58 is formed to extend in a direction oblique to the front-rear direction from an entrance open in the front end of the slider 14 toward a back side. Specifically, the cam groove 58 includes a cam engaging portion 59 formed between an end part on the entrance side and a back end part and a play portion 61 formed in the back end part.

When the connection of the housing 11 and the mating connector 90 is started, the respective cam pins 94 are inserted into the entrances of the respective cam grooves 58. In that state, the operating member 13 is rotated and the sliders 14 move leftward in FIG. 14 with respect to the housing 11, whereby the respective cam pins 94 slide on the groove surfaces of the cam engaging portions 59 of the respective cam grooves 58. The connection of the housing 11 and the mating connector 90 proceeds with the respective cam pins 94 arranged in the cam engaging portions 59 of the respective cam grooves 58 and the sliders 14 and the mating connector 90 engaged (cam engagement) in this way.

Immediately before movements of the sliders 14 are completed, the housing 11 and the mating connector 90 are disengaged. When the sliders 14 are at the movement completion position, the cam pins 94 are transferred to the play portions 61 of the cam grooves 58.

As shown in FIG. 11, an insertion groove 62 extending in the lateral direction is provided behind the respective cam grooves 58 by recessing the inner surface of the slider 14. One end of the insertion groove 62 is open in one end part (right end part of FIG. 11) of the slider 14. The respective pressed portions 29 of the second member 17 are inserted into the insertion groove 62 through an opening in the one end part of the slider 14.

The insertion groove 62 of the slider 14 includes a rear end edge part 63 extending straight in the lateral direction in the rear end and a front end edge part 64, 65 extending in a curved manner (wavy manner) in the lateral direction in a front end.

The front end edge part 64, 65 of the insertion groove 62 of the slider 14 includes a plurality of straight portions 64 arranged side by side at intervals in the lateral direction and a plurality of the pressing portions 65 projecting rearward (in a direction to reduce a groove width in the front-rear direction of the insertion groove 62) into a chevron shape between the respective straight portions 64.

In the case of this embodiment, four pressing portions 65 are arranged side by side in the lateral direction at positions corresponding to the respective pressed portions 29 in the front end edge part 64, 65 of the insertion groove 62 of the slider 14. The pressing portion 65 has the top surface 66 along the lateral direction, a preceding slant 67 inclined forward toward a right side of FIG. 11 from the right end of the top surface 66 and a succeeding slant 68 inclined forward toward a left side of FIG. 11 from the left end of the top surface 66. The preceding slant 67 and the succeeding slant 68 are inclined at an angle of inclination of 45° or less with respect to the straight portions 64.

In the front end edge part 64, 65 of the insertion groove 62 of the slider 14, a vertical dimension from the straight portion 64 to the top surface 66 of each pressing portion 65, i.e. a height of each pressing portion 65, is set to be shorter for the pressing portion 65 located more on the left side of FIGS. 14 and 15. Thus, the top surface 66 of the pressing portion 65 is arranged more forward for the pressing portion 65 located more on the left side of FIGS. 14 and 15 in the front end edge part 64, 65. In other words, the top surfaces 66 of the respective pressing portions 65 are arranged successively more forward from the pressing portion 65 located on the right side of FIGS. 14 and 15 to the pressing portion 65 located on the left side.

A dimension in the front-rear direction between the front end edge part 64, 65 and the rear end edge part 63 in the insertion groove 62, i.e. a groove width in the front-rear direction of the insertion groove 62, is smallest between the top surface 66 of the pressing portion 65 located on the right end part of FIGS. 14 and 15 and the rear end edge part 63 (see FIG. 16), but set to be larger than a dimension in the front-rear direction of the pressed portion 29 except this part with the smallest width. The pressed portions 29 are set not to contact any parts other than the corresponding pressing portions 65 and maintained in a non-engaged state while being arranged in the insertion groove 62.

### <Sealing Member>

The sealing member 15 is made of rubber and configured as a mat-like one-piece rubber plug having a thickness in the front-rear direction as shown in FIGS. 1 and 2. The sealing member 15 includes a plurality of sealing holes 71 penetrating in the front-rear direction. As shown in FIG. 2, with the sealing member 15 accommodated in the accommodation space 25 of the housing 11, the respective sealing holes 71 communicate with the respective cavities 18 and the respective through holes 34 in the front-rear direction. The wire 100 connected to the terminal fitting 20 is inserted through each sealing hole 71 in a liquid-tight manner.

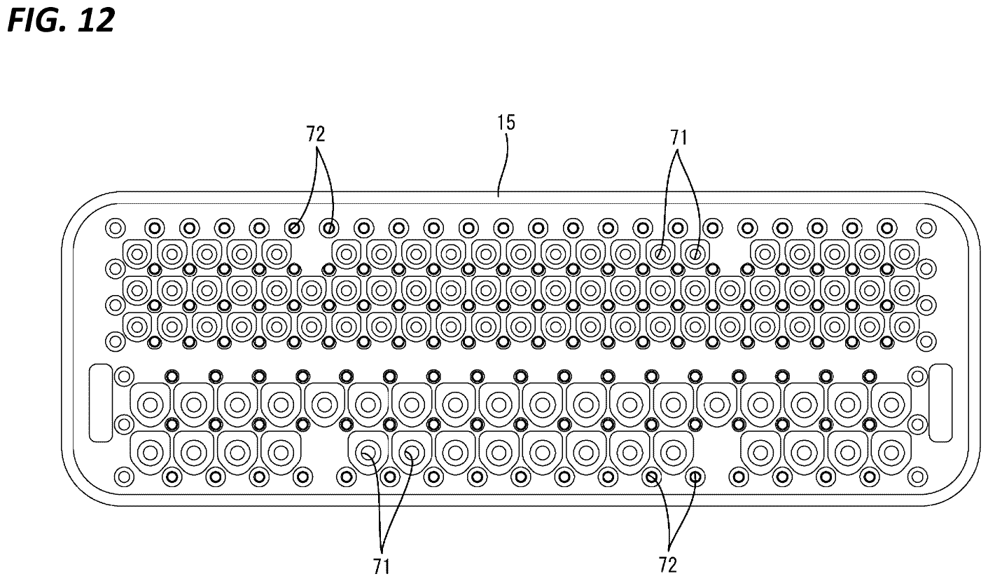

As shown in FIG. 12, a plurality of second positioning recesses 72 are recessed at four corner parts of each sealing hole 71 in the front surface of the sealing member 15. Each second positioning pin 26 is positioned and inserted into each second positioning recess 72. Similarly, a plurality of first positioning recesses (not shown), into which the respective first positioning pins 35 can be positioned and inserted, are recessed also at four corner parts of each sealing hole 71 in the rear surface of the sealing member 15.

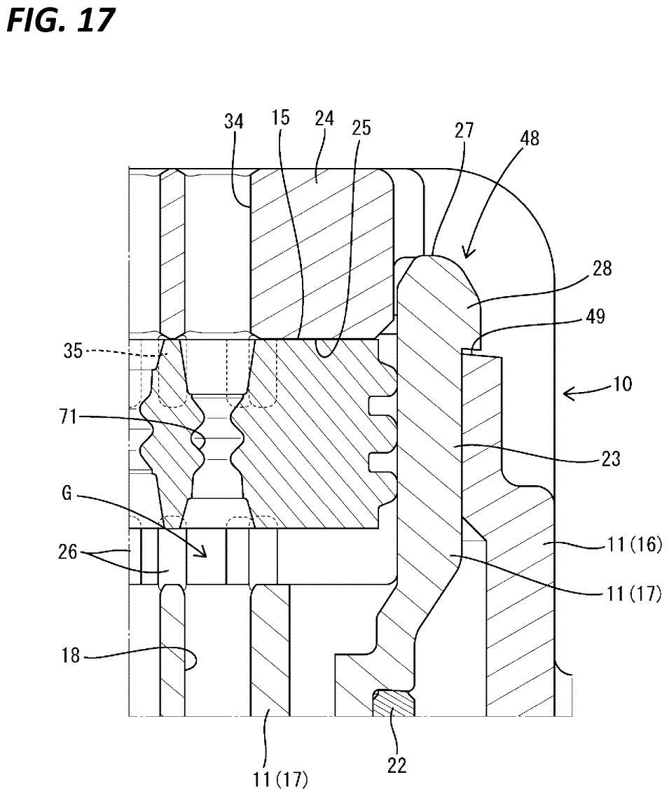

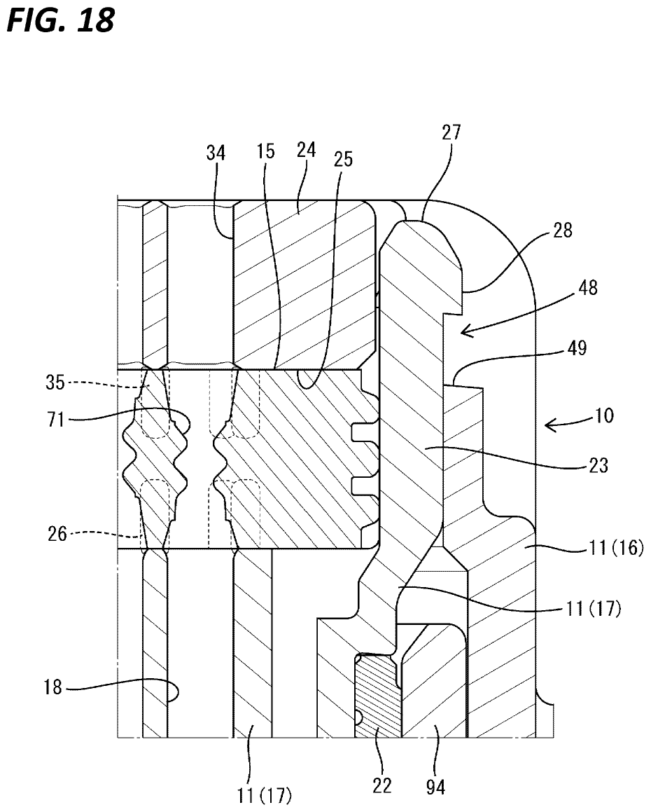

A thickness in the front-rear direction of the sealing member 15 in a natural state is set to be smaller than a distance in the front-rear direction between the front surface of the rear wall portion 24 and the rear surface of the second member 17, i.e. a dimension in the front-rear direction of the accommodation space 25, when the slider 14 is at the movement start position (see FIG. 17), and set to be larger than the dimension in the front-rear direction of the accommodation space 25 when the slider 14 is at the movement completion position (see FIG. 18). The thickness in the front-rear direction of the sealing member 15 in a compressed state is equal to the dimension in the front-rear direction of the accommodation space 25.

### <Functions of Connector>

Before the connection of the housing 11 and the mating connector 90, the operating member 13 is in a standing posture with respect to the front-rear direction and the sliders 14 are arranged at the movement start position so that the coupling portion 43 is arranged behind and away from the wire cover 12 as shown in FIG. 13. At this time, as shown in FIG. 17, the second lock projections 28 of the second lock portions 27 are arranged to be fit into the first lock portions 48 and lockable to the first lock edges 49, and the first and second members 16, 17 are held with separation restricted. The sealing member 15 accommodated in the accommodation space 25 of the housing 11 is arranged with a gap G formed between the sealing member 15 and the rear surface of the second member 17 (in a non-compressed state or natural state) while being supported by the respective first positioning pins 35 fit in the respective first positioning recesses (not shown) and the respective second positioning portions 26 fit in the respective second positioning recesses 72. The sliders 14 are arranged in the supporting holes 51 inside the fitting tube portion 33 at the movement start position. The respective pressed portions 29 (except the pressed portions 29A) are inserted into the insertion grooves 62 without being engaged with the respective pressing portions 65.

From the above state, the housing 11 and the mating connector 90 are lightly connected and the operating member 13 is rotated to tilt in an arrow direction of FIG. 13. Then, the sliders 14 start to move leftward in FIG. 13 with respect to the housing 11 by the engagement of the slide cam portions 47 and the slide cam receiving portions 57.

In the process of moving the slider 14 from the movement start position to the movement completion position, the respective pressed portions 29 face the corresponding pressing portions 65 in the moving direction of the slider 14, but are arranged away from the preceding slants 67 of the corresponding pressing portions 65. Thus, the non-engaged state of the respective pressed portions 29 and the respective pressing portions 65 is maintained. In contrast, the respective cam pins 94 of the mating connector 90 slide on the groove surfaces of the cam engaging portions 59 from the entrances of the respective cam grooves 58 and the connection of the housing 11 and the mating connector 90 proceeds.

As shown in FIG. 14, immediately before the slider 14 reaches the movement completion position, the respective cam pins 94 are transferred from the cam engaging portions 59 of the respective cam grooves 58 to the play portions 61 and a force for pulling the housing 11 and the mating connector 90 toward each other (connection resistance force) no longer acts.

Here, each pressed portion 29 contacts the corresponding pressing portion 65. Each pressed portion 29 is displaced rearward along the corresponding recess 54 while sliding on the preceding slant 67 of the pressing portion 65 according to a further movement of the slider 14. The second member 17 is pressed against the respective pressing portions 65 via the respective pressed portions 29 and relatively moves rearward with respect to the sliders 14 and the first member 16 supporting the sliders 14.

Thereafter, at the same time as the operation lock portion 45 of the operating member 13 is locked to the cover-side lock portion 38 of the wire cover 12 and the rotation of the operating member 13 is stopped as shown in FIG. 2, the movements of the sliders 14 are also stopped and the sliders 14 are held at the movement completion position with respect to the housing 11. At this time, as shown in FIG. 16, the pressed portion 29 rides on the top surface 66 of the pressing portion 65 and the contact surface 32 of the pressed portion 29 and the top surface 66 of the pressing portion 65 contact each other. As shown in FIG. 15, the cam pins 94 reach the innermost ends of the play portions 61 of the cam grooves 58.

While the cam pins 94 are displaced in the play portions 61 of the cam grooves 58, the respective pressed portions 29 slide on the preceding slants 67 of the respective pressing portions 65, whereby the second member 17 moves backward and the rear surface of the second member 17 approaches the rear wall portion 24 of the first member 16. Thus, the dimension in the front-rear direction of the accommodation space 25 is reduced and the sealing member 15 accommodated in the accommodation space 25 is compressed in the front-rear direction.

In a state where the sliders 14 have reached the movement completion position and the second member 17 have moved backward with respect to the sliders 14 and the first member 16, the sealing member 15 is compressed with a predetermined compression force. Then, each sealing hole 71 is reduced in diameter and the inner peripheral surface of each sealing hole 71 is held in close contact with the outer peripheral surface of the wire 100 in a liquid-tight manner. The outer peripheral surface of each sealing member 15 is also held in close contact with the inner peripheral surface of the tubular portion 23 in a liquid-tight manner. In this way, the housing 11 is made watertight by the sealing member 15.

In the state where the sliders 14 have reached the movement completion position and the second member 17 has moved backward with respect to the sliders 14 and the first member 16, the second lock projections 28 of the second lock portions 27 are arranged away from the first lock edges 49 behind the first lock edges 49 as shown in FIG. 18. This state can be confirmed by viewing the housing 11 from a lateral side as shown in FIG. 19. Thus, it can be known that the second member 17 has moved backward with respect to the sliders 14 and the first member 16 and the sealing member 15 is compressed in the housing 11 by confirming a state shown in FIG. 19 where the second lock portion 27 projects rearward from the first lock edge 49.

As described above, in the case of this embodiment, the respective pressed portions 29 are arranged away from the respective pressing portions 65 while the respective cam pins 94 are engaged with the cam engaging portions 59 of the respective cam grooves 58 and connection resistance is generated between the housing 11 and the mating connector 90. Thus, the respective pressed portions 29 and the respective pressing portions 65 are not in contact and the sealing member 15 is not compressed. Further, the respective pressed portions 29 also do not contact any parts of the sliders 14 other than the respective pressing portions 65. Thus, engagement resistance is not generated between the respective pressed portions 29 and the sliders 14. In contrast, with the respective cam pins 94 arranged in the play portions 61 of the respective cam grooves 58, the respective pressed portions 29 and the respective pressing portions 65 are in contact and the sealing member 15 is compressed to generate the engagement resistance, but the connection resistance is not generated. Therefore, it can be avoided that the connection resistance and the engagement resistance are simultaneously applied in a moving process of the sliders 14, and operability in connecting the housing 11 and the mating housing 91 can be improved.

Further, in this embodiment, the respective pressing portions 65 are arranged side by side in the lateral direction, which is the moving direction of the slider 14, and the top surface 66 of the pressing portion 65 located more on the left side of FIGS. 14 and 15, which is the front side in the moving direction of the slider 14, is arranged more forward. Further, the respective pressed portions 29 are also arranged side by side in the lateral direction in the second member 17, and the contact surface 32 of the pressed portion 29 located more on the left side of FIGS. 14 and 15 is arranged more forward. Thus, it can be avoided that each pressed portion 29 contacts the pressing portions 65 other than the corresponding one in the moving process of the slider 14 and, in addition, contact timings of the respective pressed portions 29 with the corresponding pressing portions 65 can be collectively set before the moving process of the slider 14 is finished. As a result, operability in connecting the housing 11 and the mating connector 90 can be further improved.

Further, in this embodiment, the first member 16 is configured as a box-shaped frame, and the accommodation space 25 is formed between the rear wall portion 24 of the first member 16 and the rear surface of the second member 17. Thus, the first member 16 can have a function of supporting the sliders 14, a function of being connected to the mating connector 90 and a function of restricting the sealing member 15 from coming out rearward.

Further, since a movement of the second member 17 with respect to the first member 16 is guided by the respective pressed portions 29 being displaced rearward along the corresponding recesses 54, the second member 17 can smoothly move backward. As just described, the respective pressed portions 29 have a function as a movement guide of the second member 17 with respect to the first member 16 in addition to a function of being pressed by the respective pressing portions 65.

### Other Embodiments of Present Disclosure

The above embodiment disclosed this time should be considered illustrative, rather than restrictive.

In the case of the above embodiment, the connector is provided with the operating member as a means for moving the sliders. However, as another embodiment, the connector may not be provided with the operating member. In the case of the other embodiment, a worker can move the sliders, such as by pressing the sliders.

In the case of the above embodiment, the lever member is configured as the sliders movable in the direction intersecting a connection direction with respect to the housing. However, as another embodiment, the lever member may be configured as a rotary lever rotatable with respect to the housing.

In the case of the above embodiment, the plurality of pressing portions are independently formed in the lateral direction in the slider. However, as another embodiment, the plurality of pressing portions may be formed such that those adjacent in the lateral direction are coupled to each other in the slider. In the case of the other embodiment, each pressing portion may not have the succeeding slant, and the preceding slant and the top surface may be connected in a stepwise manner.

In the case of the above embodiment, the plurality of pressing portions are formed in the insertion groove of the slider. However, as another embodiment, the slider may not be formed with the insertion groove and the plurality of pressing portions may be formed on the rear end of the slider in a sliding direction.

In the case of the above embodiment, the pressed portions are formed on the second member capable of accommodating the terminal fittings. However, as another embodiment, the pressed portions may be formed on a rear holder for holding the sealing member between the first member and the rear holder.

### LIST OF REFERENCE NUMERALS

10 . . . connector
11 . . . housing
12 . . . wire cover
13 . . . operating member
14 . . . slider (lever member)
15 . . . sealing member
16 . . . first member (frame)
17 . . . second member
18 . . . cavity
19 . . . front holder
20 . . . terminal fitting
21 . . . retainer
22 . . . sealing ring
23 . . . tubular portion
24 . . . rear wall portion
25 . . . accommodation space
26 . . . second positioning pin
27 . . . second lock portion
28 . . . second lock projection
29, 29A . . . pressed portion
31 . . . slit
32 . . . contact surface
33 . . . fitting tube portion
34 . . . through hole
35 . . . first positioning pin
36 . . . cover mounting portion
37 . . . projecting piece
38 . . . cover-side lock portion
39 . . . projecting portion
41 . . . bearing portion
42 . . . operation arm
43, 44 . . . coupling portion
45 . . . operation lock portion
46 . . . rotary shaft
47 . . . slide cam portion
48 . . . first lock portion
49 . . . first lock edge
51 . . . supporting hole
52 . . . rear slide rail portion (slide rail portion)
53 . . . front slide rail portion (slide rail portion)
54 . . . recess
55 . . . through hole
56 . . . resilient lock portion
57 . . . slide cam receiving portion
58 . . . cam groove
59 . . . cam engaging portion
61 . . . play portion
62 . . . insertion groove
63 . . . rear end edge part
64 . . . straight portion (front end edge part)
65 . . . pressing portion (front end edge part)
66 . . . top surface
67 . . . preceding slant
68 . . . succeeding slant
71 . . . sealing hole
72 . . . second positioning recess
90 . . . mating connector
91 . . . mating housing
92 . . . mating terminal fitting
93 . . . receptacle
94 . . . cam pin
100 . . . wire
G . . . gap

1. A connector, comprising:
a housing connectable to a mating connector;
a sealing member arranged in the housing, the sealing member sealing an outer peripheral surface of a wire; and
a lever member arranged displaceably with respect to the housing, the lever member connecting the housing and the mating connector,
the housing including a first member for supporting the lever member and a second member for accommodating the sealing member in an accommodation space formed between the first member and the second member to sandwich the sealing member in a connection direction of the housing to the mating connector,
the second member including a pressed portion,
the lever member including a pressing portion for pressing the second member in a direction to reduce a dimension in the connection direction of the accommodation space by contacting the pressed portion, and
the pressed portion being arranged in a non-engaged state with the lever member until contacting the pressing portion in a displacement process of the lever member.

2. The connector of claim 1, wherein:
the pressing portion presses the second member rearward in the connection direction,
the first member is configured as a box-shaped frame open forward in the connection direction, and
the second member is accommodated into the first member to form the accommodation space between a rear wall portion of the first member and the second member.

3. The connector of claim 1, wherein:
the first member includes a recess extending in the connection direction, and
the pressed portion is configured as a guide arranged displaceably in the recess.

4. The connector of claim 1, wherein:
the lever member includes a cam groove,
the cam groove includes a cam engaging portion to be engaged with a cam pin of the mating connector and a play portion continuous with the cam engaging portion in a back end part of the cam groove and not engaged with the cam pin, and
the pressing portion and the pressed portion are set to contact when the cam pin is located in the play portion.

5. The connector of claim 1, wherein:
the lever member is a slider configured to reach a movement completion position by moving in a direction intersecting the connection direction with respect to the first member,
a plurality of the pressing portions are arranged side by side in a moving direction of the slider in the slider,
each of the plurality of pressing portions has a top surface to be held in contact with a contact surface of the pressed portion in a connected state of the housing and the mating connector,
the top surface of the pressing portion located more on a front side in the moving direction of the slider to the movement completion position, out of the plurality of pressing portions, is arranged more forward in the connection direction,
a plurality of the pressed portions are arranged side by side to correspond to the plurality of pressing portions in the second member, and
the contact surface of the pressed portion located more on the front side in the moving direction of the slider to the movement completion position, out of the plurality of pressed portions, is arranged more forward in the connection direction.
